(19) United States
(12) Patent Application Publication
(10) Pub. No.: US 2026/0287044 A1
(43) Pub. Date: Sep. 24, 2026

(54) MULTI-SPEED CONCENTRIC TWIN-SHAFT TRANSMISSION

(71) Applicant: Eaton Intelligent Power Limited, Dublin (IE)

(72) Inventors: Carlos Henrique WINK, Granville, MI (US); Caleb L. GURD, Battle Creek, MI (US); Nelson Roberto BRANDAO, São Paulo (BR); Luigi MARSON, São Paulo (BR); Vijaya BONDE, Pune (IN); Ashish Mohanrao KANASE, Pune (IN); Shrikrishna Jaywant DESHPANDE, Pune (IN); Ajeet K. JHA, Darbhanga (IN); Vishal SHARMA, Meerut (IN); Saurabhkumar SHARMA, Pune (IN); Karan SONI, Pune (IN); Sebastiao J. DIAS, São Paulo (BR)

(21) Appl. No.: 19/475,289

(22) PCT Filed: Apr. 19, 2024
(86) PCT No.: PCT/IB2024/053864

§ 371 Date: Oct. 14, 2025

Related U.S. Application Data
(60) Provisional application No. 63/497,120, filed on Apr. 19, 2023.

(30) Foreign Application Priority Data
Aug. 14, 2023 (IN) 202311054494

(51) Int. Cl. F16H 3/097; F16H 3/085; F16H 57/021; F16H 59/40; F16H 63/30

(52) U.S. Cl. CPC F16H 3/097; F16H 3/085; F16H 57/021; F16H 59/40; F16H 63/3043; F16H 2063/3046; F16H 2200/0004; F16H 2200/0021; F16H 2200/0034

(57) ABSTRACT

A transmission can include a shaft arrangement including an input shaft configured to couple to a prime mover and an output shaft coaxially aligned with the input shaft; a plurality of drive gears supported by the shaft arrangement and including a first drive gear, a second drive gear and a third drive gear; a countershaft arrangement including a first and second countershaft supporting a plurality of pinion gears intermeshed with the first, second, and third drive gears; a clutch arrangement including a first clutch assembly and a second clutch assembly operable to lock the first, second, and third drive gears to the shaft arrangement to selectively provide four gear ratios between the input and output shafts. In some examples, the first and second clutch assemblies are electromagnetically operated.

### RELATED APPLICATIONS

This application claims priority to U.S. Provisional Patent Application Ser. No. 63/497,120 filed on Apr. 19, 2023; and to India Provisional Patent Application Serial Number 202311054494 filed on Aug. 18, 2023, the entireties of which are incorporated by reference herein.

### GOVERNMENT LICENSE RIGHTS

This invention was made with government support under Subcontract 2021096-142110 under Contract HQ0034-20-2-0007 awarded by the United States Army TARDEC, Department of Defense. The government has certain rights in the invention.

### BACKGROUND OF THE INVENTION

There is a trend in the electric vehicle market of moving to higher speed electric motors (EM), which require deeper gear ratios of the transmission in order to provide satisfactory torque and speed at the vehicle wheels.

When the transmission is integrated into a bevel gearing differential axle, one of the challenges is the unsprang mass of a motor and transmission attached to the differential axle. In this case, a high-power density, short, and lightweight transmission is desirable. There is therefore a need in the art for a transmission that is compact and can operate with various electric motors such as low-speed electric motors operating around 3,500 rpm and high-speed electric motors operating around 8,000 rpm. These electric motors may be used on commercial vehicle application (trucks and buses). In these kinds of application, multi-speed transmissions may provide benefits over direct drive (motor w/o transmission), as they can provide high torque to move a fully loaded truck at a grade, and at high road speed.

### SUMMARY

A transmission can include an input shaft configured to couple to a prime mover and an output shaft coaxially aligned with the input shaft; a plurality of drive gears supported by a shaft arrangement; a countershaft arrangement including first and second countershafts supporting a plurality of pinion gears intermeshed with the plurality of drive gears; and an electromagnetic clutch arrangement to selectively lock the plurality of drive gears to the shaft arrangement to selectively provide at least two different gear ratios between the input and output shafts.

In some examples, the plurality of drive gears includes a first drive gear, a second drive gear, and a third drive gear.

In some examples, the electromagnetic clutch arrangement is operable to selectively lock the first drive gear to the input shaft, to selectively lock the second drive gear to the input shaft and to the output shaft, and to selectively lock the third drive gear to the output shaft.

In some examples, the electromagnetic clutch arrangement includes a first electromagnetic clutch assembly and a second electromagnetic clutch assembly.

In some examples, the first electromagnetic clutch assembly is operable between: a neutral position in which the first and second drive gears are rotatable with respect to the input shaft; a first position in which the first drive gear is locked to the input shaft and the second drive gear is rotatable with respect to the input shaft; and a second position in which the first drive gear is rotatable with respect to the input shaft and the second drive gear is locked to the input shaft.

In some examples, the second electromagnetic clutch assembly is operable between: a neutral position in which the second and third drive gears are rotatable with respect to the output shaft; a first position in which the second drive gear is locked to the output shaft and the third drive gear is rotatable with respect to the output shaft; and a second position in which the second drive gear is rotatable with respect to the output shaft and the third drive gear is locked to the output shaft.

In some examples, the transmission is operable between: a first gear ratio in which the first electromagnetic clutch assembly is in the first position and the second electromagnetic clutch assembly is in the second position; a second gear ratio in which the first electromagnetic clutch assembly is in the second position and the second electromagnetic clutch assembly is in the second position; a third gear ratio in which the first electromagnetic clutch assembly is in the first position and the second electromagnetic clutch assembly is in the first position; and a fourth gear ratio in which the first electromagnetic clutch assembly is in the second position and the second electromagnetic clutch assembly is in the first position.

In some examples, the first and second electromagnetic clutch assemblies are supported by a pair of brackets supported by a housing assembly of the transmission.

In some examples, the pair of brackets are aligned to the housing assembly by one or more dowel pins.

In some examples, one of the plurality of drive gears includes a gear rim defining an internal space having an axial dimension, and wherein the electromagnetic clutch arrangement includes an electromagnetic clutch assembly located at least partially within the internal space such that a majority of an axial length of the electromagnetic clutch assembly is within the internal space.

In some examples, a power take-off location is provided that is driven by the countershaft arrangement, wherein the power take-off location has as least two possible gear speed ratios relative to the input shaft.

In some examples, the first and second countershafts are supported by cylindrical roller bearing assemblies at one end and by cylindrical roller bearing assemblies at an opposite end.

In some examples, the transmission includes anti-rotation inserts located between a housing of the transmission and the cylindrical roller bearing assemblies and between the housing and the cylindrical roller bearing assemblies.

In some examples, the input shaft is supported by an angular contact ball bearing assembly and by a roller bearing assembly.

In some examples, the roller bearing assembly is located at least partially within a cavity of the output shaft.

In some examples, the roller bearing assembly rotationally supports a thrust washer of an axial bearing assembly.

In some examples, the input shaft is axially supported by a pair of axial bearing assemblies.

In some examples, one of the axial bearing assemblies includes a spherical thrust washer.

In some examples, the transmission includes a main housing that is bolted to a front flange housing front bearings supporting the countershafts and input shaft.

In some examples, the transmission includes an adapter flange bolted to the front flange and used for mounting the transmission to the motor.

In some examples, the transmission further includes a speed sensing rotor mounted to the output shaft, the speed sensing rotor including a plurality of spaced apart teeth extending at an oblique angle to a longitudinal axis of the transmission.

In some examples, the transmission includes at least a first sensor having an axial length positioned orthogonally to the plurality of spaced apart teeth.

In some examples, the at least a first sensor is a tachograph sensor or a speed sensor.

In some examples, the at least a first sensor includes a first sensor that is a speed sensor and a second sensor that is a tachograph sensor.

In some examples, the output shaft is supported by a bearing assembly that is press fit onto the output shaft, wherein a bearing sleeve is press fit onto the bearing assembly and is secured to the front housing by a plurality of fasteners.

In some examples, the input shaft is supported by a bearing assembly that is press fit onto the input shaft, wherein a bearing sleeve is press fit onto the bearing assembly and is secured to the front housing by a plurality of fasteners.

A method of upshifting a transmission assembly driven by an electric motor from a second gear to a third gear, the method can include: providing a twin-countershaft transmission assembly including an input shaft, an output shaft, a first drive gear a second drive gear, a third drive gear, a first dog clutch, and a second dog clutch; moving the second dog clutch to be moved into a neutral position; decreasing a speed of the electric motor until a speed of the second drive gear matches a rotational speed of the electric motor; moving the first dog clutch into a neutral position, moving the second dog clutch into a first position in which the output shaft is grounded to the second drive gear; increasing the motor speed to match the speed of the first drive gear; and moving the first dog clutch into a first position in which the input shaft is grounded to the first drive gear.

A method of downshifting a transmission assembly driven by an electric motor from a second gear to a third gear, the method can include: providing a twin-countershaft transmission assembly including an input shaft, an output shaft, a first drive gear a second drive gear, a third drive gear, a first dog clutch, and a second dog clutch; moving the first dog clutch into a neutral position, decreasing a speed of the electric motor until a speed of the input shaft matches the speed of the second drive gear; moving the second dog clutch into the neutral position while the first dog clutch is actuated into a second position such that the input shaft is grounded to the second drive gear; increasing the speed of the electric motor to match the speed of the third drive gear; and moving the second dog clutch into a second position in which the third drive gear is grounded to the output shaft.

A method of upshifting a transmission assembly driven by an electric motor can include: providing a twin-countershaft transmission assembly including an input shaft, an output shaft, a first drive gear a second drive gear, a third drive gear, a first dog clutch, and a second dog clutch, wherein the first and second dog clutches are positionable to selectively place the transmission assembly in one of a first, second, third, and fourth gear ratio; positioning the first and second dog clutches such that the transmission is in the first gear ratio; and upon receiving a first system upshift request, positioning the first and second dog clutches such that the transmission is shifted from the first gear ratio directly to the third gear ratio without shifting through the second gear ratio. The method can further include positioning the first and second dog clutches such that the transmission is in the second gear ratio; and upon receiving a second system upshift request, positioning the first and second dog clutches such that the transmission is shifted from the second gear ratio directly to the fourth gear ratio without shifting through the third gear ratio.

A method of downshifting a transmission assembly driven by an electric motor can include providing a twin-countershaft transmission assembly including an input shaft, an output shaft, a first drive gear a second drive gear, a third drive gear, a first dog clutch, and a second dog clutch, wherein the first and second dog clutches are positionable to selectively place the transmission assembly in one of a first, second, third, and fourth gear ratio; positioning the first and second dog clutches such that the transmission is in the fourth gear ratio; and upon receiving a first system downshift request, positioning the first and second dog clutches such that the transmission is shifted from the fourth gear ratio directly to the second gear ratio without shifting through the third gear ratio. The method can further include positioning the first and second dog clutches such that the transmission is in the third gear ratio; and upon receiving a second system downshift request, positioning the first and second dog clutches such that the transmission is shifted from the third gear ratio directly to the first gear ratio without shifting through the second gear ratio.

In one aspect of the present disclosure, a transmission includes a housing configured to receive a gear mechanism and a plurality of shafts, an actuation mechanism on an exterior portion of the housing, a power take-off generator mounting area, an input shaft coupled to an electric machine and configured to provide power to the electric machine, and an output shaft coupled to the input shaft and configured to transfer power from the input shaft to a differential mechanism.

### BRIEF DESCRIPTION OF THE DRAWINGS

FIG. 1 is a perspective view of a transmission and motor assembly, according to various examples of the disclosure.

FIG. 2 is a first perspective view of a transmission assembly of the assembly shown in FIG. 1.

FIG. 3 is a second perspective view of the transmission assembly shown in FIG. 2.

FIG. 4 is a longitudinal side cross-sectional view of the transmission assembly shown in FIG. 2.

FIG. 5 is a enlarged portion of the view shown in FIG. 4.

FIG. 6 is a longitudinal perspective cross-sectional view of the transmission assembly shown in FIG. 2.

FIG. 7 is a perspective view of a portion of the transmission assembly shown in FIG. 2.

FIG. 8 is a first lateral cross-sectional view of the transmission assembly shown in FIG. 2.

FIG. 9 is a second lateral cross-sectional view of the transmission assembly shown in FIG. 2.

FIG. 10 is a third lateral cross-sectional view of the transmission assembly shown in FIG. 2.

FIG. 11 is a fourth lateral cross-sectional view of the transmission assembly shown in FIG. 2.

FIG. 12 is a fifth lateral cross-sectional view of the transmission assembly shown in FIG. 2.

FIG. 13 is a sixth lateral cross-sectional view of the transmission assembly shown in FIG. 2.

FIG. 14 is a perspective view of a portion of the transmission assembly shown in FIG. 2.

FIG. 15 is a perspective view of a portion of the transmission assembly shown in FIG. 2.

FIG. 16 is a perspective view of a portion of the transmission assembly shown in FIG. 2.

FIG. 17 is a side view of the transmission assembly portion shown in FIG. 16.

FIG. 18 is a longitudinal side cross-sectional view of the transmission assembly portion shown in FIG. 17.

FIG. 19 is a perspective view of a portion of the transmission assembly shown in FIG. 2.

FIG. 20 is a side view of the transmission assembly portion shown in FIG. 19.

FIG. 21 is a longitudinal side cross-sectional view of the transmission assembly portion shown in FIG. 19.

FIG. 22 is a perspective view of a portion of the transmission assembly shown in FIG. 2.

FIG. 23 is a cross-sectional view of a portion of the transmission assembly shown in FIG. 2.

FIG. 24 is a cross-sectional view of a portion of the transmission assembly shown in FIG. 2.

FIG. 25 is a perspective view of a speed rotor of the transmission assembly shown in FIG. 2.

FIG. 26 is an exploded perspective view of a portion of the transmission assembly shown in FIG. 2.

FIG. 27 is a perspective view of an output bearing cover of the transmission assembly shown in FIG. 2, and shown at FIG. 26.

FIG. 28 is a perspective view of an output bearing sleeve of the transmission assembly shown in FIG. 2, and shown at FIG. 26.

FIG. 29 is an exploded perspective view of a portion of the transmission assembly shown in FIG. 2.

FIG. 30 is a perspective view of an input bearing cover of the transmission assembly shown in FIG. 2, and shown at FIG. 29.

FIG. 31 is a perspective view of an input bearing sleeve of the transmission assembly shown in FIG. 2, and shown at FIG. 29.

FIG. 32 is a perspective view of a second example of a transmission assembly usable with the motor assembly of FIG. 1, according to various examples of the disclosure.

FIG. 33 is a cross-sectional view of the transmission assembly shown in FIG. 32.

FIG. 34 is a perspective view of a portion of the transmission assembly shown in FIG. 32, including a shifting mechanism.

FIG. 35 is a perspective view of the shifting mechanism shown in FIG. 34.

FIG. 36 is a top view of the shifting mechanism shown in FIG. 35.

FIG. 37 is a side view of the shifting mechanism shown in FIG. 37.

FIG. 38 is a perspective view of a portion of the transmission assembly shown in FIG. 32, including a speed rotor and first and second sensing arrangements.

FIG. 39 is a perspective view of a portion of the speed rotor and the first sensing arrangement shown in FIG. 38.

FIG. 40 is a perspective view of a portion of the speed rotor and the second sensing arrangement shown in FIG. 38.

FIG. 41 is a cross-sectional view of the speed rotor shown in FIG. 38.

FIG. 42 is a perspective view of the speed rotor shown in FIG. 38.

FIG. 43 is a schematic of a first speed operating state of the transmission shown in FIGS. 2 and 32.

FIG. 44 is a schematic of a second speed operating state of the transmissions shown in FIGS. 2 and 32.

FIG. 45 is a schematic of a third speed operating state of the transmission shown in FIGS. 2 and 32.

FIG. 46 is a schematic of a fourth speed operating state of the transmission shown in FIGS. 2 and 32.

FIG. 47 is a block diagram showing an example shifting process in an upshift mode.

FIG. 48 is a block diagram showing an example shifting process in a downshift mode.

### DETAILED DESCRIPTION

Various examples of the disclosure address advantages linked to power dense, multiple speed, highly integrated, electric vehicle solutions. For example, twin countershafts may allow for each gear stage to handle large loads, while a shift mechanism may allow the gear stages to be placed very close together, e.g., substantially closer than conventional gear stages. In other examples, the concentric positioning of the various gears and shafts may allow for the transmission to be closely integrated with the electric machine.

Various examples of the disclosure include an ultra-compact, high power density (e.g., up to 50 kW/L) four-speed electric vehicle (EV) transmission utilizing twin counter shafts, three sets of gears, and an innovative shifting mechanism. For example, the shifting mechanism may reduce or virtually eliminate the space between gear sets that is typically required for shift forks, resulting in a smaller overall package. The gear architecture of various examples is designed to be concentric where, e.g., the input shaft is in line with, or co-axial with, the output shaft.

In various examples, when the transmission is integrated into a bevel gearing differential axle, one of the challenges is the unsprung mass of motor and transmission attached to the differential axle. In this case, a high-power density, short, and lightweight transmission may be advantageous. Examples of the four-speed transmission according to this disclosure addresses these challenges. For example, the transmission may weigh, e.g., 80 kg and may have a total length of, e.g., 380 mm.

In various examples, the transmission according to this disclosure may be installed on a vehicle as a central drive configuration connecting to the rear axle through an output flange and propeller shaft. In this example, the ultra-compact transmission may allow for shorter propeller shafts leaving more room for the battery package.

As there is a trend in the EV market of moving to higher speed electric motors (EM), which typically require deeper gear ratios of the transmission in order to provide satisfactory torque and speed at the vehicle wheels, the transmission according to examples of the disclosure has a 8.09 to 1 overall ratio which pairs fittingly with both low-speed EMs, e.g., 3,500 rpm, and high-speed EMs, e.g., 8,000 rpm.

Examples of the architecture of the transmission include a twin-countershaft, three-gear layer arrangement. In an example, the power generated from the electric machine enters the system through an input shaft, and this input power is then distributed evenly to the twin countershafts. For example, the input power is distributed evenly to the twin countershafts either through the layer-one or layer-two pinion, depending on the selected speed. In an example, power then leaves the system through the output shaft, which can then be passed to an external final axle gear ratio and differential.

When in first speed mode, the power enters the system through the layer-one drive pinion, then is sent to and distributed evenly between the two countershafts, and is subsequently passed to the layer-three driven gear and out of the system.

When in second speed mode, the power enters the system through the layer-two drive pinion, then is sent to and distributed evenly to the two countershafts and is subsequently passed to the layer-three driven gear and out of the system.

When in third speed mode, the power enters the system through the layer-one drive pinion, then is sent to and distributed evenly to the two countershafts and is subsequently passed to the layer-two driven pinion (previously used as the drive pinion in second speed mode) and out of the system.

When in fourth speed mode, the input shaft and output shaft are directly coupled through the clutch architecture, bypassing all gears.

In various examples, the shifting mechanism is formed of, or includes, shifting inputs, for example, electronic inputs that select if layer-one or layer-two gearsets are to be locked to the input shaft, and that selects if layer-two or layer-three is to be locked to the output shafts. The shifting inputs may be electronically connected to electromagnetically operated dog clutches internal to the transmission assembly.

In various examples, the four-speed transmission may be installed on a vehicle as a central drive configuration connecting to the rear axle through an output flange and propeller shaft. In this example, the novel ultra-compact transmission may allow for shorter propeller shafts, thus leaving more room for the battery package. In another aspect, the transmission can also be integrated to the differential rear axle. In that case, the output flange is removed and the output shaft connects directly to the differential pinion gear. Also, the transmission housing may be modified to be bolted to the differential enclosure.

### General Transmission Architecture

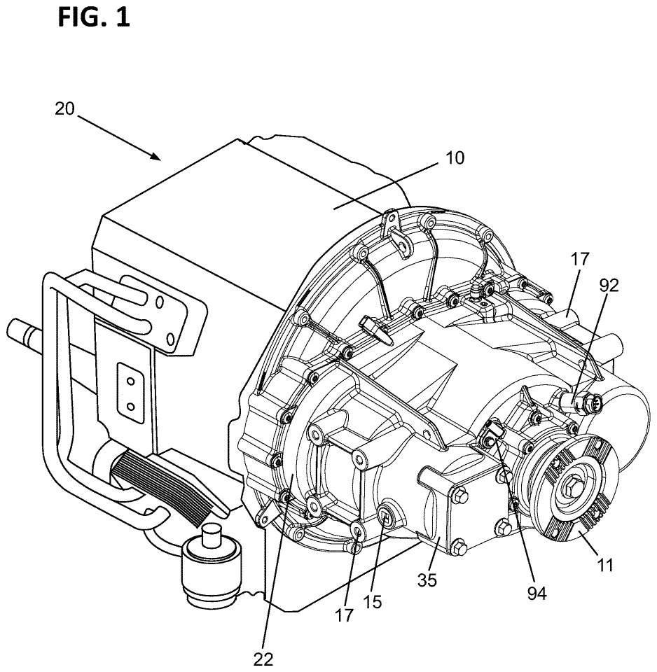

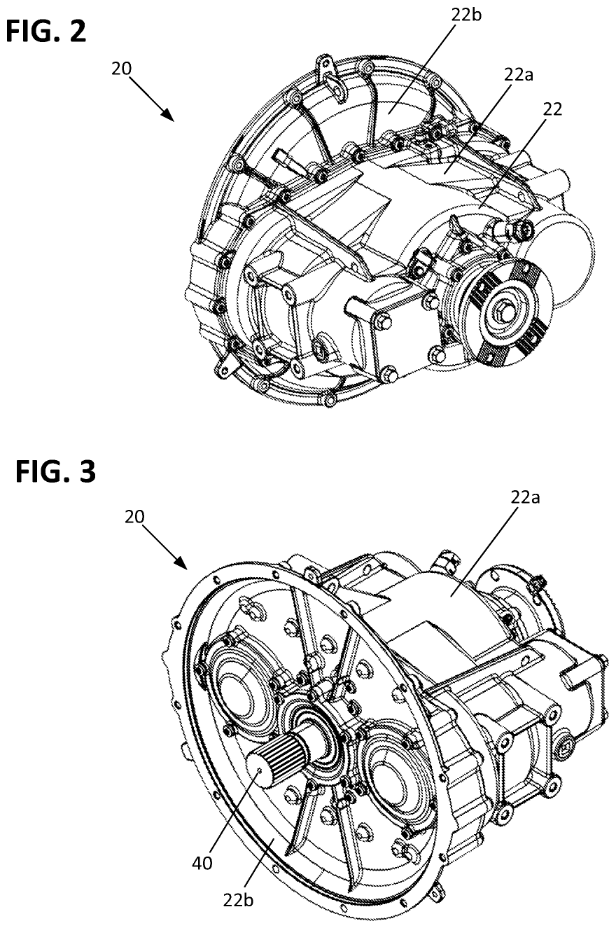

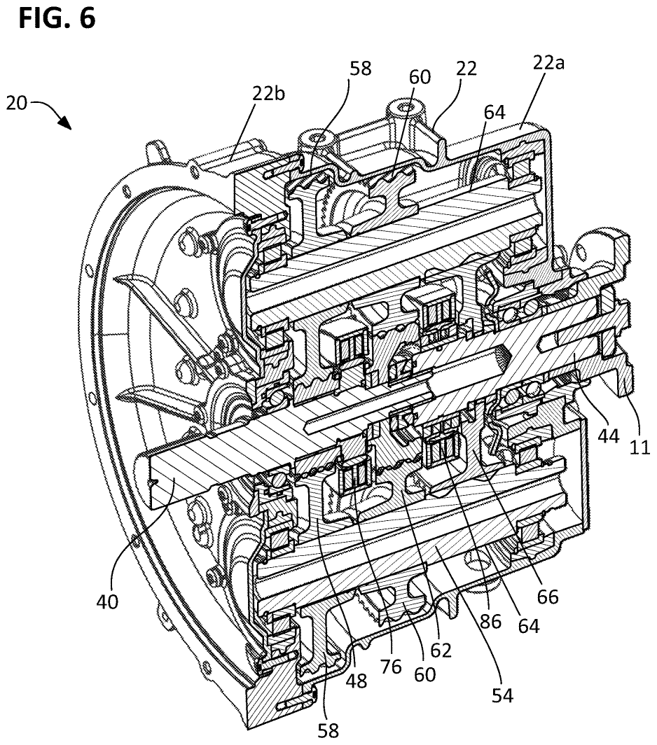

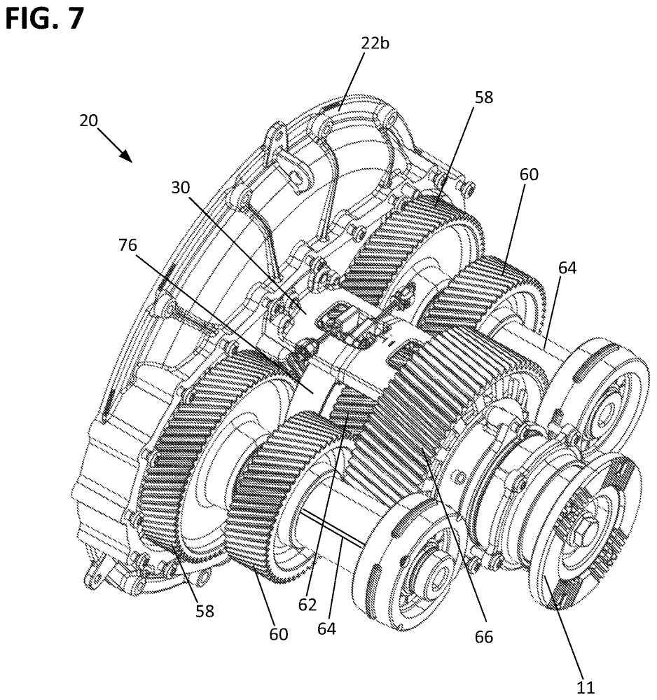

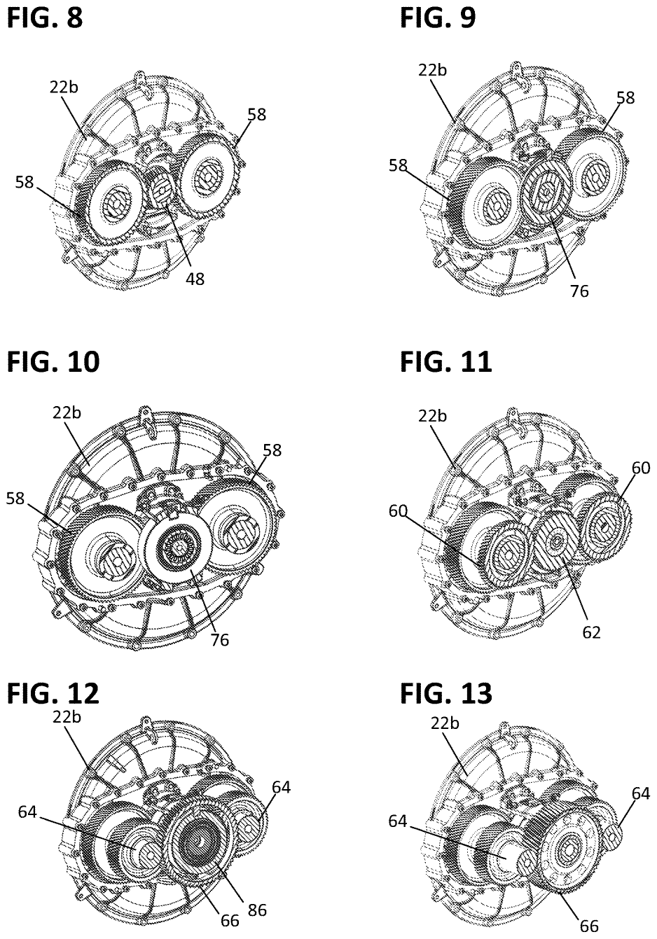

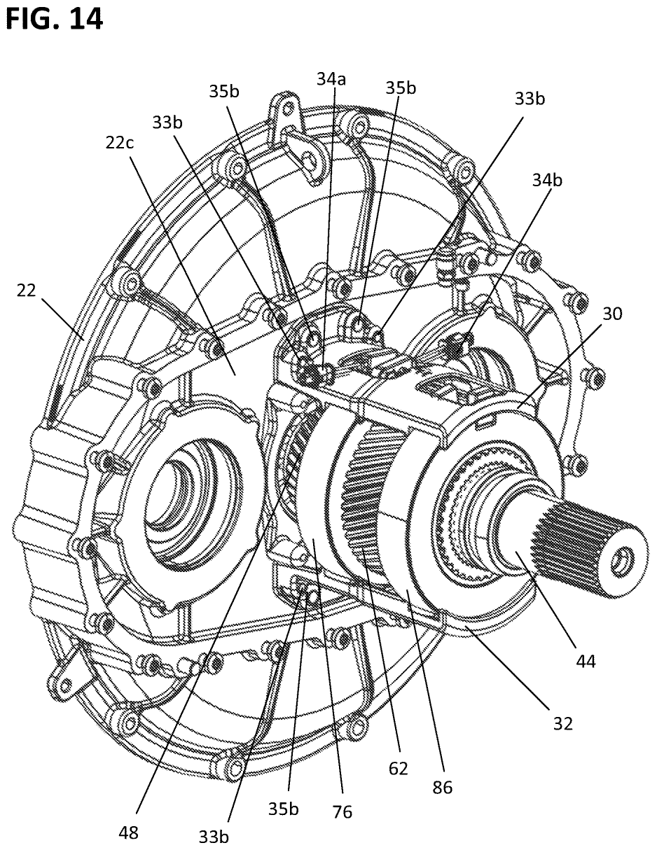

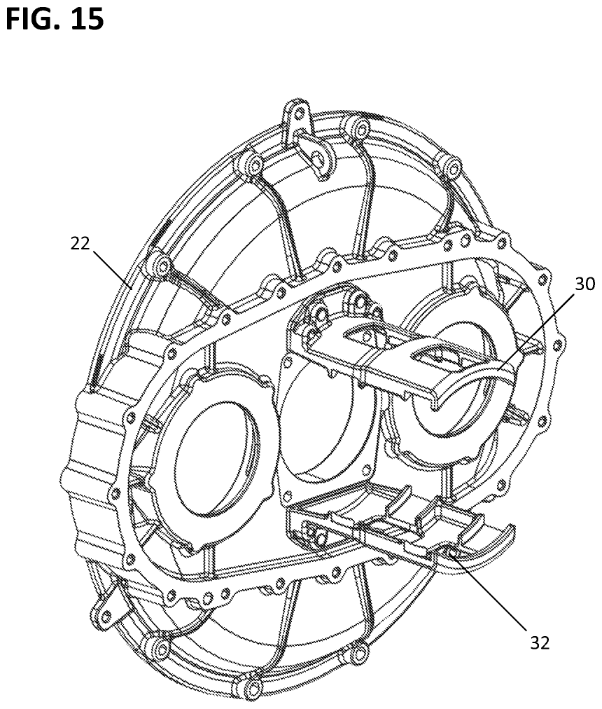

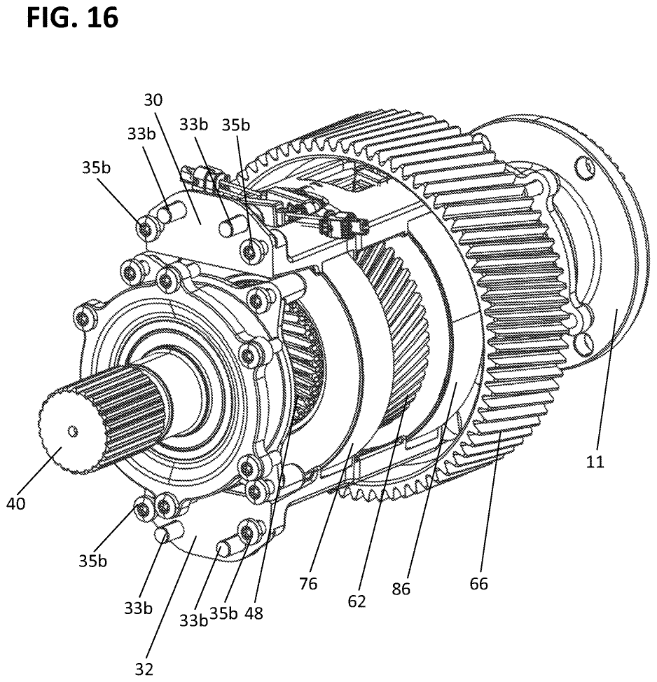

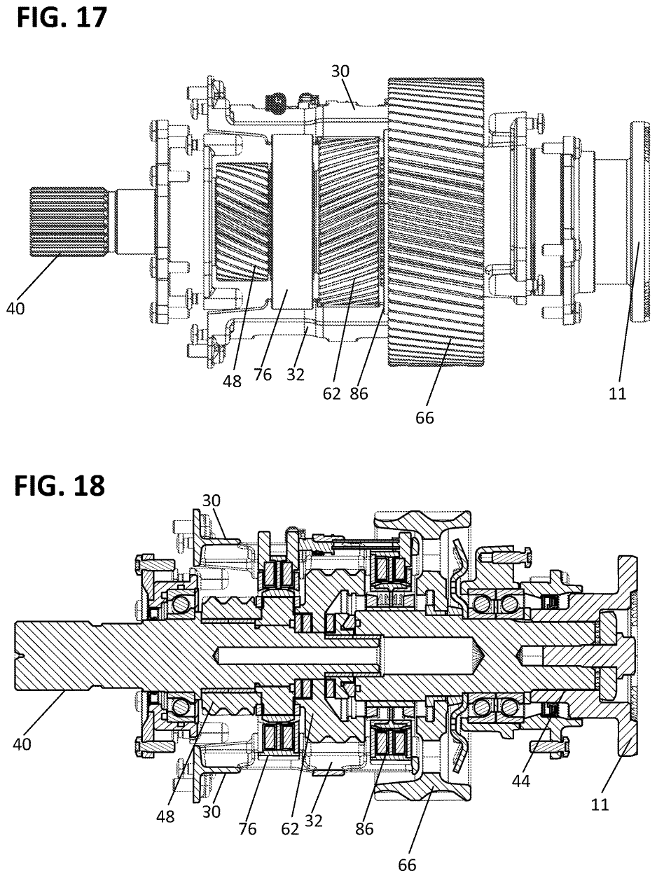

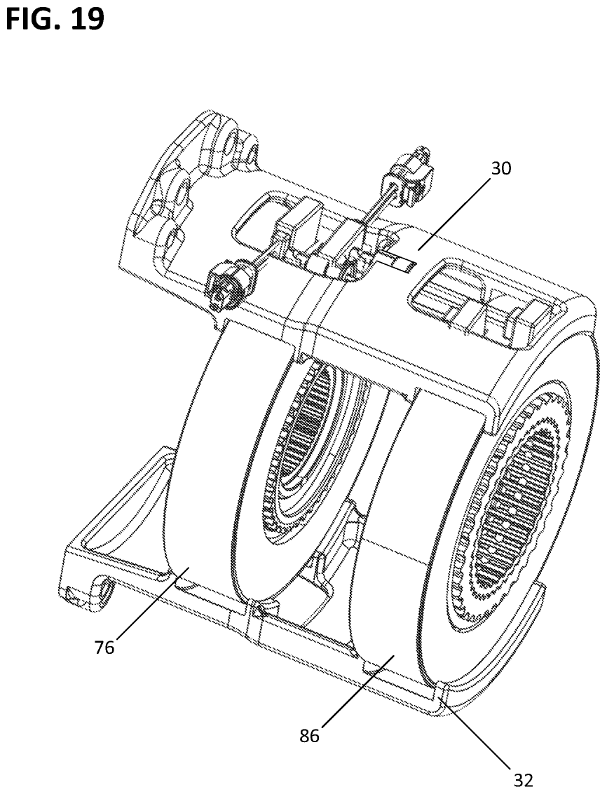

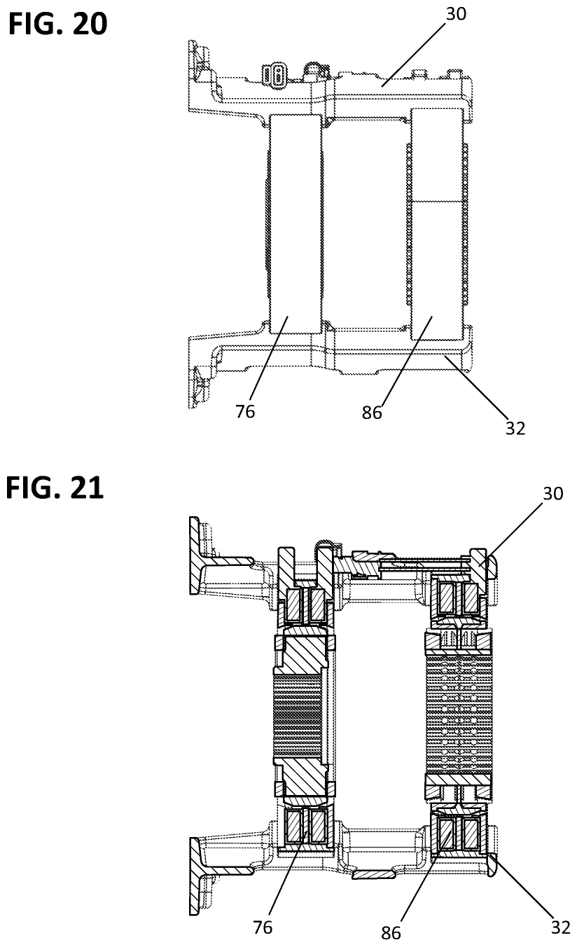

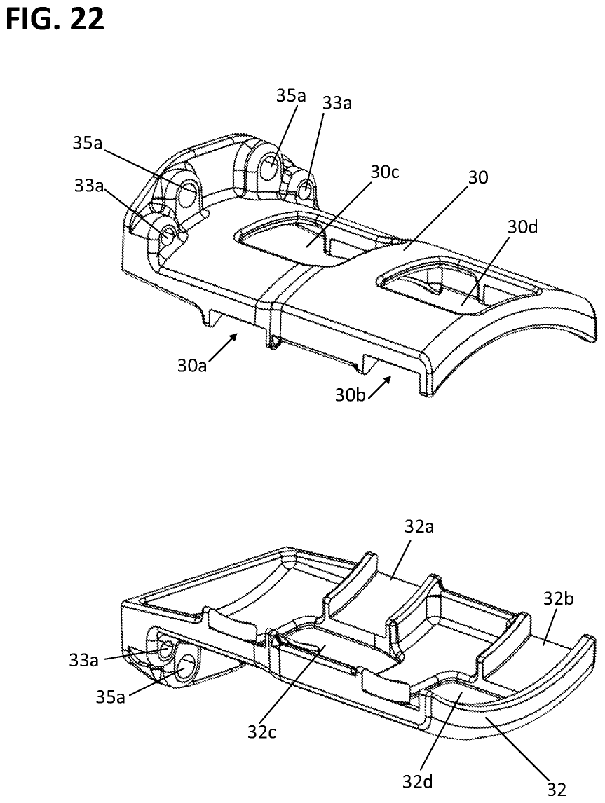

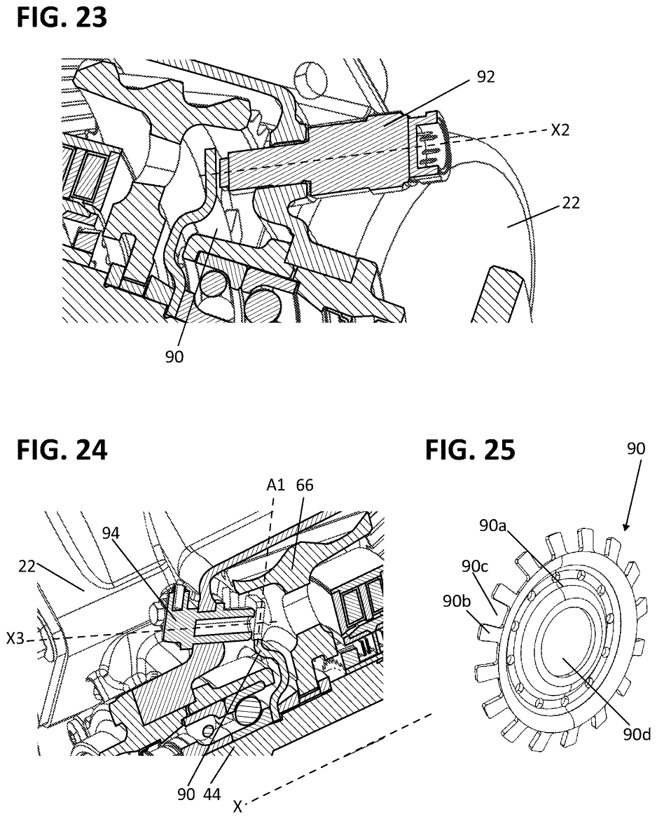

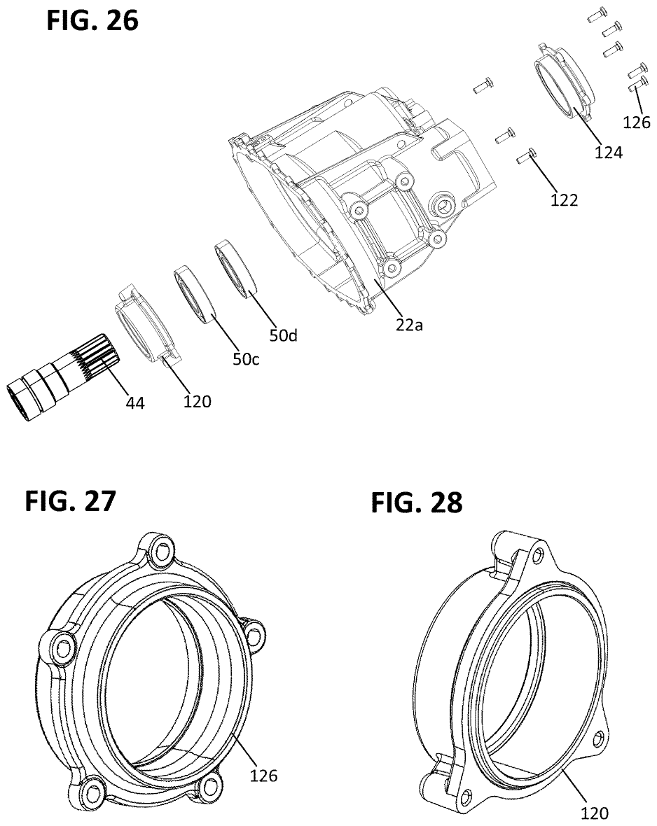

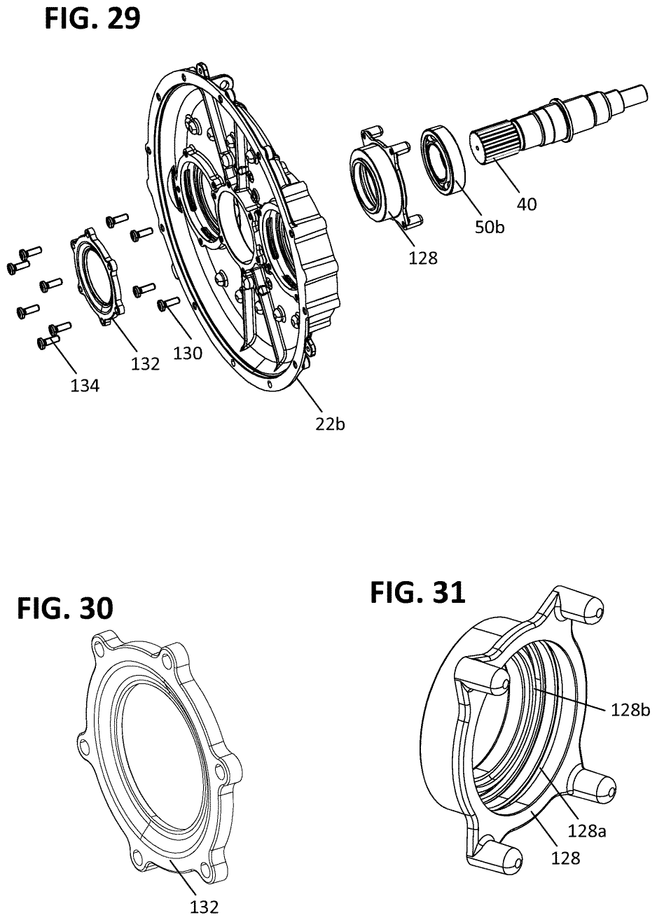

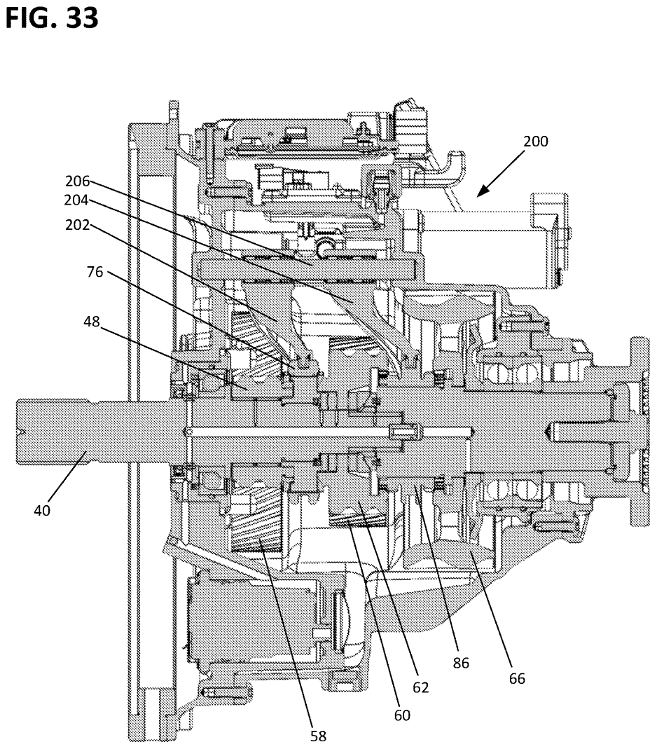

Referring to FIGS. 1-35, a transmission 20, driven by an electric motor 10 via an input shaft 40, according to the present disclosure is presented. In the example shown, the transmission 20 is compatible with an electric motor 10 that is packaged as an integrated power plant assembly including a motor core, inverter, and other components manufactured by Cascadia Motion of Wilsonville, OR, USA and sold as model iM-425. In one aspect, transmission 20 is configured as a twin counter shaft transmission with a housing assembly 22 including a main housing 22a bolted to a front cover 22b. Advantageously, when switching to a new motor, just the adapter flange and the input shaft splines are changed, keeping the remainder of the transmission the same. This creates a flexible and cost-effective solution for different applications and customers. The transmission 20 is also shown as including an input shaft 40 supporting a first drive gear 48 and a second drive gear 62, an output shaft 44 supporting an end of the input shaft 40, and a third drive gear 66, wherein the input shaft 40 is coaxially aligned but independently rotatable with respect to the output shaft 44. The transmission 20 is also provided with first and second counter shafts 52, 54 each supporting a first pinion gear 58 intermeshed with the first drive gear 48, a second pinion gear 60 intermeshed with the second drive gear 62, and a third pinion gear 64 intermeshed with the third drive gear 66. It is noted that in some drawings, the pinion gear 64 is depicted without teeth although it is to be understood that the pinion gear 64, in all cases, is provided with teeth compatible with those of the third drive gear 66. The transmission 20 is also shown as including a power take-off location 35 driven by the counter shaft 54, an output flange 11 mounted to the output shaft 44, a breather, an oil fill plug 15, and mounting points 17 integrated into the housing 22a.

In one aspect, transmission 20 is provided with first and second electromagnetic dog clutches 76, 86 that can be electrically activated via a control signal to selectively ground the drive gears 48, 62, 66 to the input and output shafts 40, 44.

In the configuration shown, the first drive gear 48 is provided with a first engagement arrangement 48a while the second drive gear 62 is provided with a second engagement arrangement 62a, each of the engagement arrangements 48a, 62a having externally facing teeth. In the example shown, the first and second engagement arrangements 48a, 62a are toothed rings secured to the first and second drive gears 48, 62, respectively. However, the first and second engagement arrangements 48a, 62a could be integrally formed with the respective drive gears 48, 62. The second drive gear 62 is also shown as being provided with a third engagement arrangement 62b with internally facing teeth that are integral to the body of the drive gear 62. Similarly, the third drive gear 66 is provided with a fourth engagement arrangement 66a with internally facing teeth that are integral to the body of the drive gear 66. The engagement arrangements 62b, 66a could be alternatively separately formed and mounted to the respective drive gears 62, 66.

In one aspect, the first dog clutch 76 is provided with a hub 76a that is splined to the input shaft 40, an axially displaceable outer ring 76b having internally facing teeth splined to the hub 76a, and an actuator assembly 76c including a stator and a pair of coils. The second dog clutch 86 is similarly provided with a hub 86a splined to the output shaft 44, an axially displacement outer ring 86b, and an actuator assembly 86c including a stator and pair of coils. The outer ring 86b carries a first engagement ring 86d having externally facing teeth and a spaced apart second engagement ring 86e also having externally facing teeth. As explained further below in a later section, each of the first and second dog clutches 76, 86 are operable between first and second positions, from a neutral unpowered position, by activation of one of a pair of coils in the actuator assembly 76c, 86c. For example, when a first coil of the actuator assembly 76c, 86c is actuated, the associated outer ring 76b, 86b will move from the neutral position in a direction D1 into a first position. Likewise, when a second coil of the actuator assembly 76c, 86c is actuated, the associated outer ring 76b, 86b will move from the neutral position in a direction D2 into a second position. As the actuator assemblies 76c, 86c are inherently a part of the electromagnetic clutch assemblies 76, 86, the actuator assemblies 76c, 86c are internal to the main housing 22a. Power can be provided to the clutch assemblies 76, 78 via cabling and connectors 34a, 34b which can be connected, for example, to a vehicle CAN system.

### Compact Arrangement

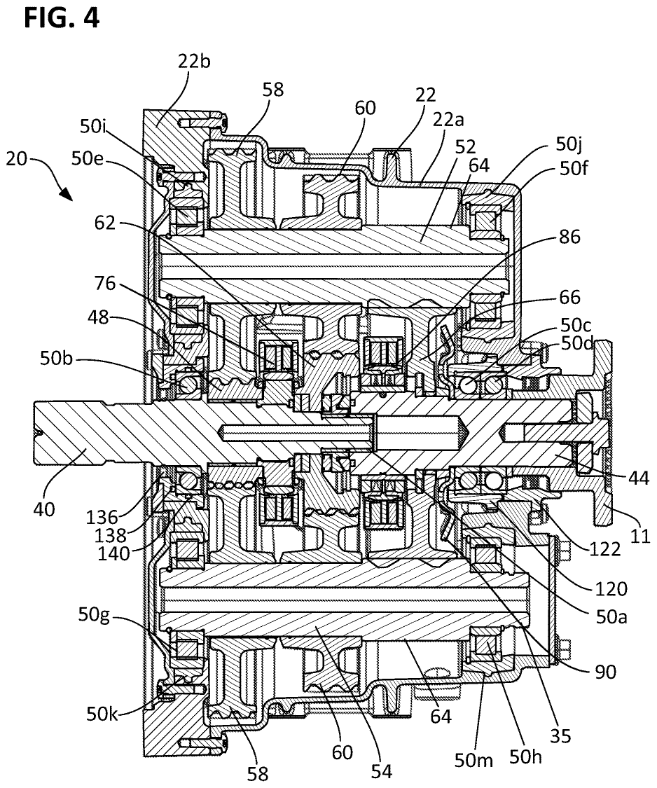

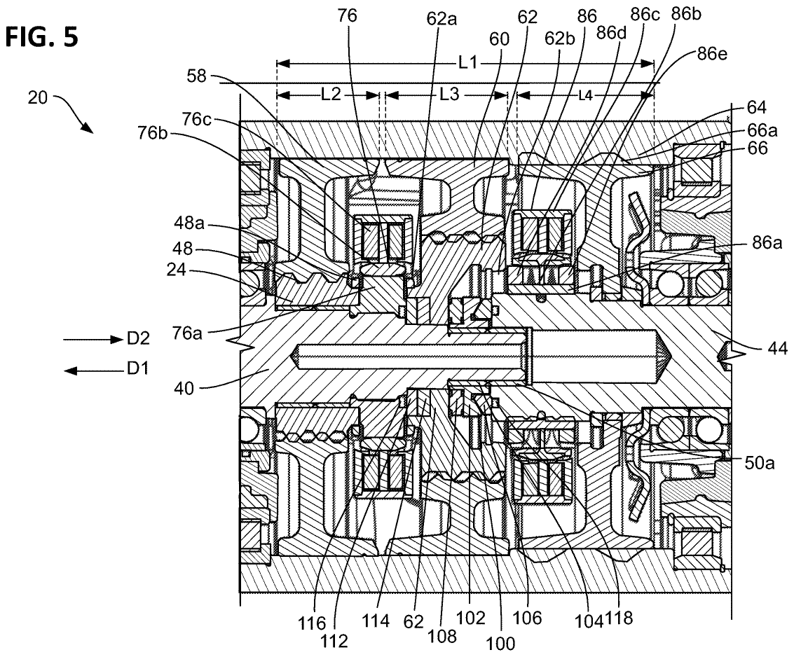

One advantage of the disclosed arrangement is that the transmission 20 can be made more compact with a shorter overall axial length. As can be most easily seen at FIGS. 4 and 5, the first dog clutch 76 is located between the first and second drive gears 48, 62, while the second dog clutch 86 is located between the second and third drive gears 62, 66.

With reference to FIG. 5, it can be seen that the gear mechanism 24 is provided in a highly compact axial arrangement even though two clutches 76, 86 are provided between the drive gears 48, 62, 66 and pinion gears 58, 60, 64. In one aspect, it can be seen that the total length L1 between the end of the first drive gear 48 and the opposite end of the third drive gear 66, which is the same as the length between the end of the first pinion gear 58 and the end of the third pinion gear 64 is almost entirely defined by combined lengths L2, L3, L4 of the outer toothed-rim of the gear 66 and the bases of pinion gears 58, 60 with very little axial space therebetween. In one aspect, the axial lengths of these portions make up over 90% of the total length L1. Advantageously, this arrangement significantly shortens the overall axial length of the transmission 20. In one aspect, the compact arrangement is primarily accomplished by placing the clutch 86 within the interior space defined by the outer rim of the gear 66. As can be seen most easily at FIG. 5, the majority of the axial length of the clutch 86 is within the interior space of the outer rim of the gear 66. In the example shown, over 75 percent of the axial length of the clutch 86, for example about 90 percent, is within the interior space of the outer rim of the gear 66. The compact axial arrangement is also accomplished by placing the clutch 76 within the interior spaces defined by the bases of the pinion gears 58, 60, which have a larger axial length in comparison to the outer toothed rims of the pinion gears 58, 60.

With reference to FIGS. 14 to 21, it can be seen that this compact arrangement is made possible, in part, through the use of a pair of oppositely facing support brackets 30, 32 which are mounted to and extend axially from the adapter flange 22c of the housing 22. In the configuration shown, each of the support brackets is provided with a pair of first apertures 33a to receive a pair of alignment dowel support pins 33b extending from adapter flange 22c and is provided with a pair of second apertures 35a to receive a pair of fasteners 35b for securing the brackets to the adapter flange 22c. The fasteners can be, for example, bolts. Other numbers and combinations of fasteners and pins may be used. In one aspect, the support brackets 30, 32 are provided with first channels 30a, 32a and second channels 30b, 32b that support the clutches 76, 86 in both the radial and axial directions. Specifically, the channels 30a, 32a receive and support the outer actuator assembly 76c of the clutch 76 while the channels 30b, 32b receive and support the outer actuator assembly 86c of the clutch 86. In one example, the support brackets 30, 32 are identical to each other. In one example, the support brackets 30, 32 are formed from a metal material, such as cast aluminum. With reference to FIG. 22, it can be seen that the brackets 30, 32 are provided with apertures 30c, 30d, 32c, 32d. In one aspect, portions of the actuator assemblies 76c, 86c extend through the apertures in the housing 22 and allow for power and control cabling and connectors 34a, 34b to be routed to the actuators 76, 86.

### Thrust Arrangement 100

In one aspect, the gear 62 works as a driver as well as a driven gear. Accordingly, the gear 62 has a relative speed (e.g., 8,000 rpm) with adjacent components while axial forces are also present. With reference to FIG. 5, it can be seen that a thrust arrangement 100 is provided to manage this dynamic. As shown, a sleeve 102 is provided about and rotatably supported by input shaft 40 via a needle bearing assembly 104 which supports the position of the input shaft. A needle bearing 50a is also provided to support the position of the output shaft 44. As shown, the thrust arrangement 100 further includes a spherical thrust washer 106 disposed between the sleeve 102 and an axial end of the output shaft 44, a thrust washer 108 disposed on an opposite side of the sleeve 102 and adjacent the gear 62, and additional thrust washers 112, 114 provided between an opposite side of the gear 62 and a shoulder of the input shaft 40. The thrust arrangement 100 is further shown as including a first wave spring 116 and a second wave spring 118 to preload the axial bearings and for preventing skidding while providing adequate bearing operation. In one aspect, the spherical thrust washer 106 and sleeve 102 compensate for shaft misalignment.

### Bearing Assemblies

With reference to FIG. 4, various bearing assembly arrangements are illustrated. For example, shaft 40 is supported, at one end, by a needle bearing 50a housed within an internal portion of the shaft 44, and at another end, by a bearing assembly 50b that is configured as an angular contact ball bearing assembly. The shaft 44 is supported by the needle bearing 50a and is further supported by a pair of bearing assemblies 50c, 50d, each of which is configured as an angular contact ball bearing assembly. The counter shaft 52 is supported, at one end, by a bearing assembly 50e that is configured as a cylinder roller bearing assembly, and at another end by a bearing assembly 50f that is configured as a cylinder roller bearing assembly. Similarly, the counter shaft 54 is supported, at one end, by a bearing assembly 50g that is configured as a cylinder roller bearing assembly, and at another end by a bearing assembly 50h that is configured as a cylinder roller bearing assembly. In one aspect, the cylinder roller bearings located at the front of the assembly provide for easy assembly and high load capacity. Regarding thrust load, it is noted that the disclosed gearing is designed for low net thrust load as the thrust load generated by one gear is almost cancelled out by the thrust load of similar magnitude and opposite direction by the other gear mesh in the power path. In one aspect, the cylindrical roller bearings provide for high load capacity and a relatively smaller outer diameter to ensure a compact enclosure at their location.

In one aspect, the bearings 50e, 50f, 50g, 50h are supported within the housing 22 by annular inserts which may be referred to as anti-rotation inserts 50i, 50j, 50k, 50m. The anti-rotation inserts 50i, 50j, 50k, 50m are received into openings in the housing 22 and in turn receive the bearings 50c, 50d, 50e, 50f. In one example, the anti-rotation inserts are formed from a different material than the housing material and provide a more dimensionally stable structure for supporting the bearings 50c, 50d, 50e, 50f, which may be formed from the same material. In one example, the housing 22 is formed from aluminum while the bearings and anti-rotation inserts are formed from a steel or cast-iron material. In one example, cast iron inserts are over-molded to high-pressure aluminum parts for preventing the bearing outer races from rotating relatively to the housings, especially at transmission operating temperatures when the thermal expansion of aluminum increases the diameter of the housings. As shown, the anti-rotation inserts 50i, 50j, 50k, 50m are provided with rib structures that interact with rib structures formed in the housing 22 such that when the anti-rotation inserts are inserted into the housing 22, the anti-rotation inserts are unable to rotate relative to the housing. In an alternative arrangement, similar anti-rotation inserts may also be provided for bearings 50b, 50c, and 50d.

With reference to FIG. 4 and 26 to 28, aspects associated with the bearing assemblies 50c, 50d are further illustrated. With the disclosed housing design, it is observed that if the bearings 50c, 50d are press-fitted on a sub-assembly of the output shaft 44 first, it can be difficult to install the housing 22a over the bearings 50c, 50d, as it is a blind assembly. Further, holding the outer race of the bearings 50c, 50d from the inside makes it is difficult to install a snap ring at that location. On the other hand, if the bearings are press-fit onto the housing 22a first, it is then difficult to press on the output shaft 44 in the main assembly as the press-force required is higher. In order to simplify assembly, the disclosed design includes a bearing sleeve 120 that is press fit onto the outer races of the bearings 50c, 50d after the bearings 50c, 50d have been press fit onto the output shaft 44. The assembly of the shaft 44, bearings 50c, 50d, and sleeve 120 can then be assembled into the transmission assembly after which the housing 22a can be installed thereover. At this stage, fasteners 122 can be used to secure the bearing sleeve 120 to the housing 22a. The disclosed design further includes a rear bearing cover 124 that is bolted to the housing 22a with fasteners 126. The rear bearing cover 124 abuts the outer race of the bearing assembly 50d and functions to constrain the outer races of the bearings 50c, 50d in an axial direction. The inner races of the bearings 50c, 50d are also constrained axially between a speed rotor 90, discussed later, and a washer disposed between the bearing 50d and the output flange 11. In the example shown, the bearing sleeve 120 and the rear bearing cover 124 are made of aluminum. Alternatively, other materials may be used, such as cast iron, polymer, and composites. The disclosed bearing sleeve 120 and bearing cover assembly 124 allow the bearing outer race and inner race to be pressed to the right amount of interference for proper operation for the bearing, and ultimately makes feasible the use of a simple two-piece enclosure architecture using housing 22a and cover 22b.

With reference to FIG. 4 and 29 to 31, aspects associated with the bearing assembly 50b are further illustrated in which the same assembly considerations as described for bearings 50c, 50d exist. As shown, a bearing sleeve 128 is press fit onto the outer race of bearing assembly 50b after the bearing assembly 50b has been press fit onto the input shaft 40 to form an input shaft subassembly. This assembly is then installed into the transmission 20 after which the cover 22b can be mated onto the housing 22a. At this point, the sleeve 128 can be secured to the cover 22b via fasteners 130. Once the cover 22b is installed, a bearing cover 132 can be installed onto the cover 22b via fasteners 134 to axially fix the sleeve 128 and thus the outer race of the bearing assembly 50b. As shown at FIG. 4, the bearing sleeve 128 houses an oil seal 136 to the input shaft 40. In one example, the bearing sleeve 128 is made of aluminum, but can be made of other materials such as cast iron, various polymers, and composites. In one aspect, the bearing sleeve 128 includes a first groove 128a, facing in a radial inward direction, and includes a second groove 128b facing in an axial direction towards the output shaft 44. The first groove 128a houses a seal 138 in the form of an O-ring to prevent the outer race of the bearing 50b from rotating or creeping in the case where interference between the outer race of the bearing 50b and the sleeve 128 is reduced due to thermal expansion under high operating temperatures. The second groove 128b houses a spring 140 in the form of a wave spring to provide an axial preload force against the bearing 50b. This design allows the bearing outer race and inner race to be pressed to the right amount of interference for proper operation for the bearing 50b, and ultimately it makes feasible the use of a simple two-piece enclosure architecture using housing 22a and cover 22b.

### Speed Sensing Arrangement

Referring to FIGS. 23 to 25, the transmission 20 is shown as further including a sensing arrangement including a speed rotor 90, a tachograph sensor 92 for detecting an RPM (revolutions per minute) of the output shaft 44, and a speed sensor 94 for detecting movement of the shaft 44. In one aspect, the speed rotor 90 is provided with a main body 90a having a central aperture 90d through which the shaft 44 extends. The main body 90a is secured to the shaft 44 such that the speed rotor 90 rotates with the rotation of the output shaft 44. Advantageously, the speed rotor 90 is located within the interior area defined by the rim of the drive gear 66 on the side opposite the clutch 86 to result in a further compact arrangement. In one aspect, the speed rotor 90 is provided with a plurality of teeth or tines 90b extending radially from the main body 90a. The teeth 90b also extend axially at an oblique angle A1 from a main surface of the main body 90a and from the longitudinal axis X of the shaft 44. In one aspect, the teeth 90b are spaced apart from each other with open spaces 90c therebetween. In one example, the speed rotor 90 is a metal stamping piece for lightweight and low cost. As illustrated, the rotor 90 can be press fit onto the output shaft 44 and axially constrained by a step on the output shaft 44 and the rear output shaft bearing 50c. Such an arrangement reduces the axial position variation of the speed rotor 90 to the sensors 92, 94 based on the number of components and dimensions of the transmission stack up.

In one aspect, the tachograph sensor and the speed sensor are both mounted to the housing 22 such that their respective longitudinal axes X2, X3 are disposed at an angle that is orthogonal to the teeth 90b disposed at the angle A1, and at an angle that is therefore oblique to the longitudinal axis X of the shaft 44. Advantageously, this arrangement reduces the axial length of the transmission 20 as sensors of this type are typically mounted perpendicular to the transmission output shaft, which requires more space for the rotor, resulting in increased transmission length. In one example, the disclosed design allows for the transmission 20 to have an axial length that is 30 mm less than would otherwise be the case with differently oriented sensors. Both of the tachograph and speed sensors 92, 94 sense rotation of the shaft 44 by sensing the passing of the teeth 90b and spaces or slots 90c of the speed rotor 90 to collect speed information from the rotor 90.

The tachograph and speed sensors 92, 94 can be provided as any variety of sensors capable of sensing movement of the speed rotor 90 without actually contacting the speed rotor 90, such as inductive impulse sensors, hall-effect sensors, optical sensors, etc.

### Speed Selection and Operation

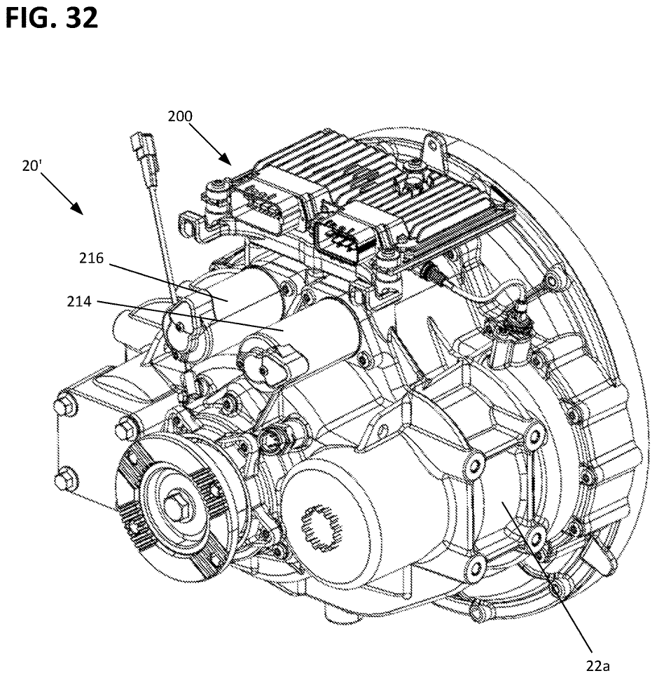

With continued reference to FIGS. 4 and 5 and to the schematics provided at FIGS. 32-35, the operation of the first and second dog clutches 76, 86 can result in the selection of four different speeds using three gear sets, as follows. It is noted that reference to the dog clutch 76 being in a first position is a position in which the dog clutch 76 operably grounds the input shaft 40 to the gear 48, that reference to the dog clutch being in a second position is a position in which the dog clutch 76 operably grounds the input shaft 40 to the gear 62, and that reference to the dog clutch 76 being in a neutral position is one in which the gears 48 and 62 can rotate with respect to the input shaft 40. It is noted that reference to the dog clutch 86 being in a first position is a position in which the dog clutch 86 operably grounds the output shaft 44 to the gear 62, that reference to the dog clutch being in a second position is a position in which the dog clutch 86 operably grounds the output shaft 44 to the gear 66, and that reference to the dog clutch 86 being in a neutral position is one in which the gears 62 and 66 can rotate with respect to output shaft 44.

To achieve the first position of the first dog clutch 76 from either neutral or second position, a first coil of the actuator assembly 76c is energized such that the outer ring 76b is moved in the direction D1 and such that the internally facing teeth of the outer ring 76b engage with the first engagement arrangement 48a of the first drive gear 48, thereby resulting in the first drive gear 48 being grounded to the input shaft 40. To achieve the second position of the first dog clutch 76 from either the neutral or first position, a second coil of the actuator assembly 76c is energized such that the outer ring 76b is moved in the direction D2 and such that the internally facing teeth of the outer ring 76b engage with the second engagement arrangement 62a of the second drive gear 62, thereby resulting in the second drive gear 62 being grounded to the input shaft 40. To achieve the neutral position of the first dog clutch 76, neither of the coils of the actuator 76c are energized (i.e., the actuator 76c is de-energized), such that the outer ring 76b moves into a center position and out of engagement with both the first and second drive gears 48, 62. In one aspect, the first dog clutch 76 can be moved into the neutral position either passively (e.g., with centering springs) or actively (e.g., with the coils themselves).”

To achieve the first position of the second dog clutch 86 from either neutral or second position, a first coil of the actuator assembly 86c is energized such that the outer ring 86b is moved in the direction D1 and such that the externally facing teeth of the first engagement ring 86d engage with the third engagement arrangement 62b of the second drive gear 62, thereby resulting in the second drive gear 62 being grounded to the output shaft 44. To achieve the second position of the second dog clutch 86 from either the neutral or first position, a second coil of the actuator assembly 86c is energized such that the outer ring 86b is moved in the direction D2 and such that the externally facing teeth of the second engagement ring 86e engage with the fourth engagement arrangement 66a of the third drive gear 66, thereby resulting in the third drive gear 66 being grounded to the output shaft 44. To achieve the neutral position of the second dog clutch 86, neither of the coils of the actuator 86c are energized (i.e., the actuator 86c is de-energized), such that the outer ring 86b moves into a center position and out of engagement with both the second and third drive gears 62, 66. In one aspect, the second dog clutch 86 can be moved into the neutral position either passively (e.g., with centering springs) or actively (e.g., with the coils themselves).”

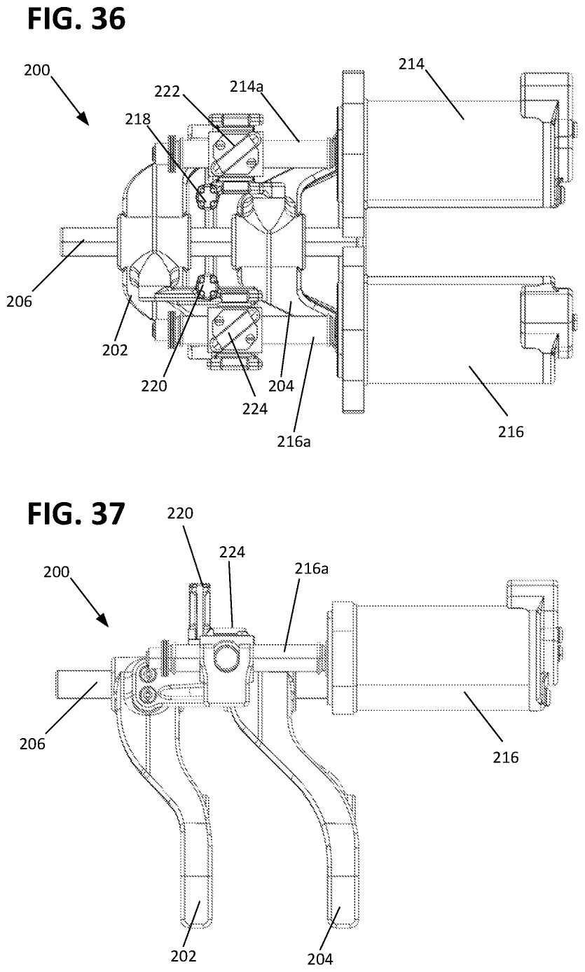

### Transmission Assembly of FIGS. 32 to 42

Referring to FIGS. 32 to 42, a second example of a transmission assembly 20′ is shown. The transmission assembly 20′ of FIGS. 32 to 42 is largely similar to the transmission assembly 20 of FIGS. 1 to 31 in that a three-gear layer arrangement is provided with the same gearing ratios. Accordingly, where such similarities occur, like reference numbers are used and the above description for transmission 20 is applicable for the transmission assembly 20′. Instead of repeating those similarities here, this section will focus on the primary differences between transmission assembly 20′ in comparison to transmission assembly 20.

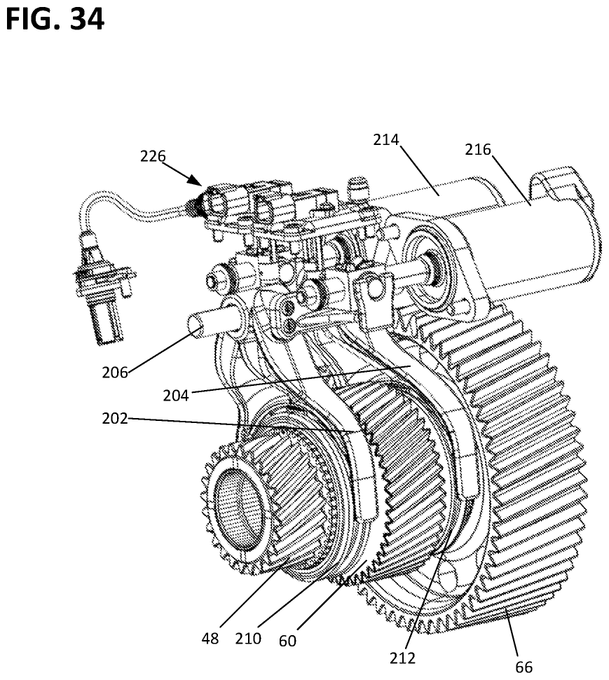

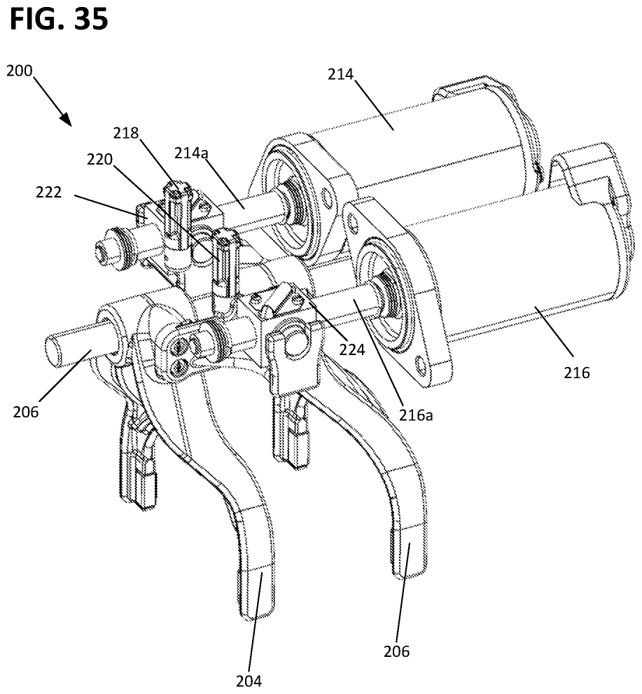

A primary difference of transmission assembly 20′ is that the dog clutches 76, 86 are mechanically actuated by an external shifting system 200 rather than utilizing electromagnetic internal dog clutches. With such an arrangement, the shifting system 200 is provided with a first shift fork 202 that operates the dog clutch 76 via a yoke 210 and a second shift fork 204 that operates the dog clutch 86 via a yoke 212. As shown, the shift forks 202, 204 slide along a common rail 206 and are respectively operated by electric actuators 214, 216 which are external to the transmission main housing 22a. The dog clutches 76, 86 interact with the shaft 40 and gears 48, 62, and 66 in a manner similar as described above for transmission assembly 20. Referring to FIGS. 35 to 37, it can be most easily seen that a shaft 214a associated with the actuator 214 is mechanically coupled to the first shift fork 204 on a first side of the rail 206 while a shaft 216a associated with the actuator 216 is mechanically coupled to the second shift fork 206 on a second side of the rail 206. In one aspect, the shafts 214a, 216a extend in a direction that is parallel to the length of the rail 206. With continued reference to FIGS. 35 to 37, it can be seen that a first magnet or sensor target 218 is mechanically coupled to the shaft 214a while a second magnet or sensor target 220 is coupled to the shaft 216a. Additionally, a third magnet or sensor target 222 is mechanically coupled to the shaft 214a while a fourth magnet or sensor target 224 is coupled to the shaft 216a. With such an arrangement, the magnets or sensor targets 218, 220, 222, 224 move with actuation of the respective shafts 214a, 216a such that the position of the first and second shift forks 204, 206, and thus the dog clutches 76, 86 can be determined by a corresponding sensing arrangement 226. In some examples, the sensing arrangement 226 uses hall effect sensors to detect the positions of the magnets or sensor targets 218, 220, 222, 224. It is noted that a single sensor for each shaft could be utilized, and in the example shown, two are shown for each shaft for redundancy purposes.

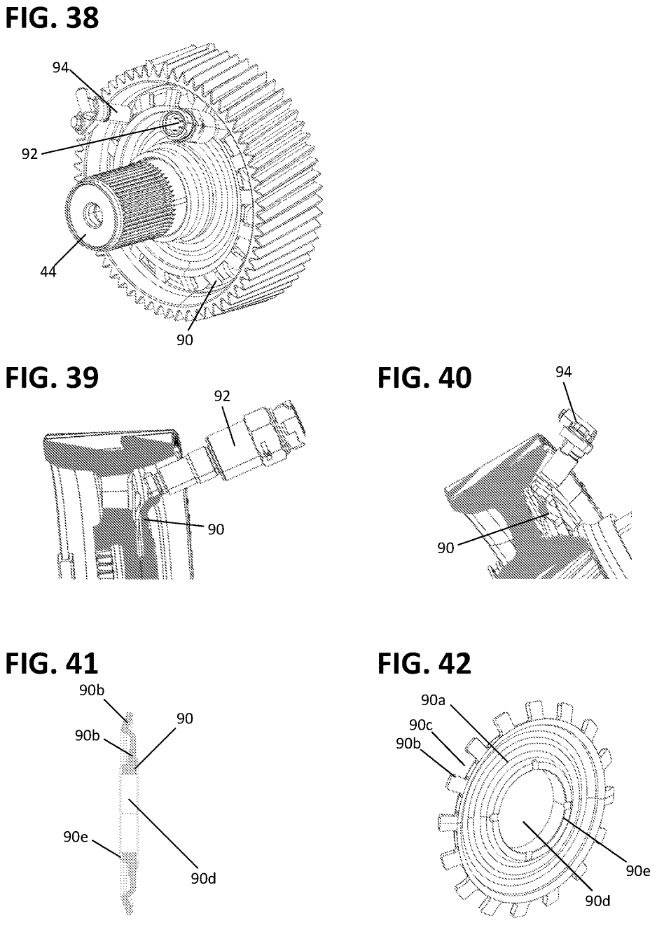

As shown at FIGS. 38 to 42, the transmission 20′ is provided with an alternatively configured speed rotor 90 mounted to a shaft 44 having modified diameters. As with the speed rotor previously described, the speed rotor 90 shown at FIGS. 38 to 42 is provided with a central opening 90d and plurality of teeth or tines 90b extending radially and axially from the main body 90a, wherein the teeth 90b are spaced apart from each other with open spaces 90c therebetween. In contrast to the previously described speed rotor, the speed rotor 90 of FIGS. 38 to 42 is formed through a net forging process and incorporates an integral thrust washer portion 90e.

### Shifting Methods and Strategies

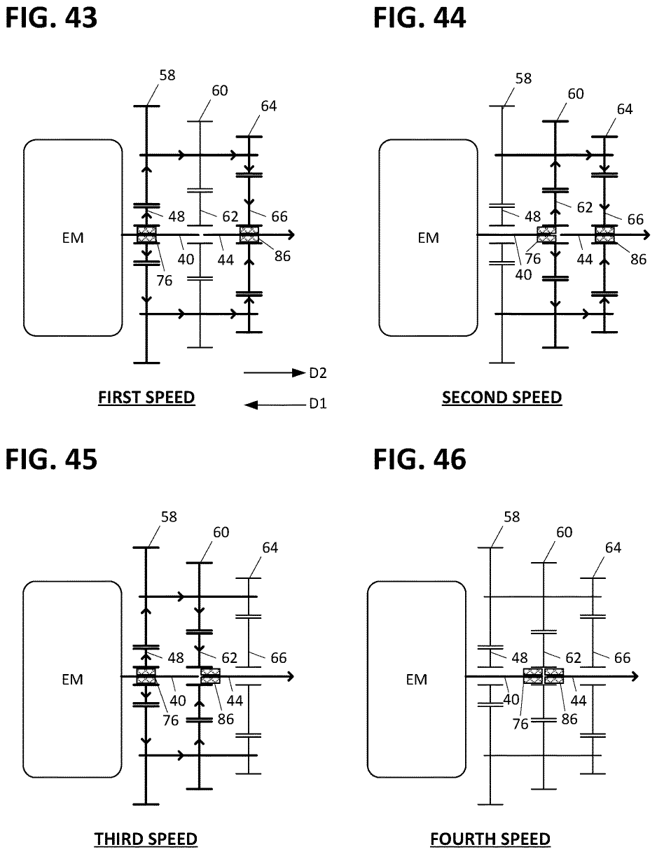

Referring to FIGS. 43 to 48, shifting methods and strategies are shown that can be used with transmission assembly 20 and transmission assembly 20′.

To achieve a first gear or speed, as schematically shown at FIG. 43, the first and second dog clutches 76, 86 are moved or energized such that the first dog clutch 76 is in the first position and the second dog clutch 86 is in the second position. As a result, when in first gear or speed, the power enters the transmission 20, 20′ through the first drive gear 48 and to the first pinion gear 58, then is distributed evenly to the first and second countershafts 52, 54, and is then passed through the third pinion gear 64 to the third driven gear 66 and out of the transmission via the output shaft 44. In one aspect, the gear ratio may be 8.09 to 1.

To achieve a second gear or speed, as schematically shown at FIG. 44, the first and second dog clutches 76, 86 are moved or energized such that the first dog clutch 76 is in the second position and the second dog clutch 86 is in the second position. As a result, when in the second gear or speed, the power enters the transmission 20, 20′ through the second drive gear 62 and then to the second pinion gear 60, then is distributed evenly to the first and second countershafts 52, 54 and is then passed through the third pinion gear 64 to the third drive gear 66 and out of the transmission via the output shaft 44. In one aspect, the gear ratio may be 4.07 to 1.

To achieve a third gear or speed, as schematically shown at FIG. 45, the first and second dog clutches 76, 86 are moved or energized such that the first dog clutch 76 is in the first position and the second dog clutch 86 is in the first position. As a result, when in third gear or speed, the power enters the transmission 20, 20′ through first driven gear 48 and to the first pinion gear 58, then is distributed evenly to the two countershafts 52, 54 and is then passed through the second pinion gear 60 to the second driven gear 62 and out of the transmission via the output shaft 44. In one aspect, the gear ratio may be 1.99 to 1.

To achieve a fourth gear or speed, as schematically shown at FIG. 46, the first and second dog clutches 76, 86 are moved or energized such that the first dog clutch 76 is in the second position and the second dog clutch 86 is in the first position. As a result, when in fourth gear or speed, the input shaft 40 and output shaft 44 are directly coupled by grounding the second drive gear 62 to both the shafts 40, 244, thus bypassing all gears. In one aspect, the gear ratio may be 1 to 1.

With respect to the above gear speeds, it is noted that since the power take off (PTO) output at 35 is defined by the rotational speed of the countershaft 54, the first dog clutch 76 can be moved to achieve different PTO output speeds. For example, in the first position of the first dog clutch 76, a first or low PTO speed is achieved. When the first dog clutch 76 is moved into the second position, a second or high PTO speed is achieved which is approximately same speed of the motor.

One of the challenges with the disclosed transmission architecture is shifting from second speed into third speed, and downshifting from third speed to second speed. A special shifting strategy of the dog clutches was developed and is described below in which the motor speed is controlled to equalize speeds without the use of a powershift, synchronizer, or clutch package.

In one example operation, in which the transmission 20, 20′ is upshifted from the second gear or speed to the third gear or speed, the second dog clutch 86 is energized or moved into the neutral position, the motor speed is then revved down until the second drive gear 62 speed matches the rotational speed of the motor (e.g., the motor speed is decreased by 4.07 times the initial motor speed), the first dog clutch 76 is then moved into the neutral position, the second dog clutch 86 is then actuated into the first position, the motor speed is then revved up to match the speed of the first drive gear 48 (e.g., the motor speed is increased by 1.99 times), and then the first dog clutch 76 is actuated into the first position whereby the upshift from the second gear or speed to the third gear or speed is completed.

In one example operation, in which the transmission 20, 20′ is downshifted from the third gear or speed to the second gear or speed, the first dog clutch 76 is moved or energized into the neutral position, the motor speed is revved down until the speed of the input shaft 40 matches the speed of the second drive gear 62 (e.g., the motor speed is decreased from 3717 rpm to 1869 rpm), the second dog clutch 86 is then moved or energized into the neutral position while the first dog clutch 76 is actuated into the second position, the motor speed is then revved up to match the speed of the third drive gear 66 (e.g., the motor speed is increased from 1869 rpm to 7600 rpm), and then the second dog clutch is energized into the second position, whereby the downshift from the third gear or speed to the second gear or speed is completed.

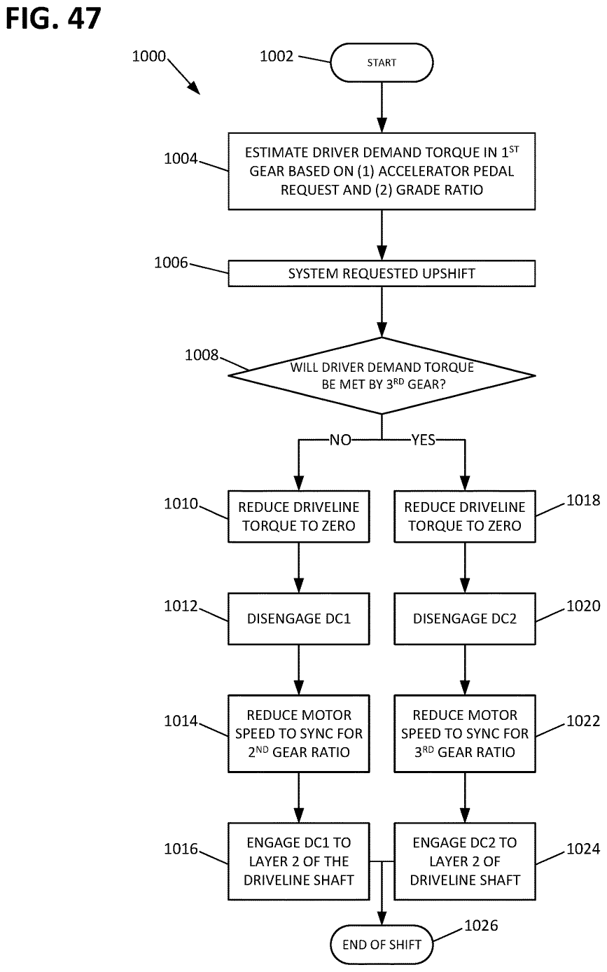

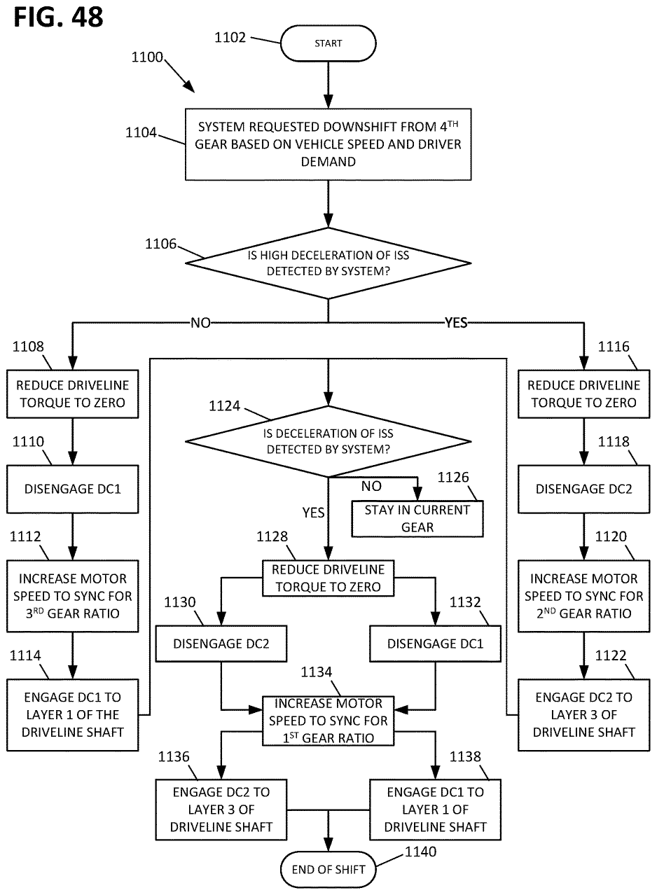

An alternative to the above shifting strategy is illustrated at FIGS. 47 and 48 in which shifting between the second and third gears or layers is altogether eliminated. As shown in FIG. 47, an upshift method 1000 is shown in which the method is initiated at step 1002 when the transmission is in the first gear. At step 1004, a controller (e.g., the electronic controller for the vehicle and/or the transmission) estimates driver demand torque in the first gear by using a pedal request or position value from the vehicle accelerator pedal and by referencing the grade ratio of the road upon which the vehicle is driving, as is known in the art. At step 1006, a system requested upshift is generated when it is determined at step 1004 by the controller that an upshift should occur to meet driver demands, as is known in the art. At step 1008, a determination is made as to whether the driver demand torque can be met by the third gear of the transmission. When driver demand cannot be met by the third gear, the method proceeds through steps 1010 to 1016 where driveline torque is reduced to zero at step 1010, the first dog clutch is disengaged at step 1012, electric motor speed is reduced to sync for the second gear ratio at step 1014, and the first dog clutch is engaged to the second layer of the driveline shaft at step 1016 to place the transmission in the second gear. Once in the second gear, any further upshifting of the transmission will be from the second gear directly to the fourth gear by engaging the second dog clutch to the second layer of the driveline shaft. When driver demand can be met by the third gear, the method proceeds through steps 1018 to 1024 where driveline torque is reduced to zero at step 1018, the second dog clutch is disengaged at step 1020, electric motor speed is reduced to sync for the third gear ratio at step 1022, and the first dog clutch is engaged to the third layer of the driveline shaft at step 1024 to place the transmission in the third gear without shifting through the second gear. Once in the second gear, any further upshifting of the transmission will be from the third gear to the fourth gear. The shifting process is ended at step 1026 after either step 1016 or step 1024.

As shown in FIG. 48, a downshift method 1100 is shown in which the method is initiated at step 1102 when the transmission is in the fourth gear. At step 1104, a system requested downshift from fourth gear is generated based on vehicle speed and driver demand, as is known in the art. At step 1106, it is determined whether a high deceleration (i.e., deceleration exceeding a threshold parameter or value) of the input shaft system (ISS) is detected. When deceleration is below a threshold value or parameter, the method proceeds through steps 1108 to 1114 where driveline torque is reduced to zero at step 1108, the first dog clutch is disengaged at step 1110, electric motor speed is increased to sync for the third gear ratio at step 1112, and the first dog clutch is engaged to the first layer of the driveline shaft at step 1114. When deceleration exceeds a threshold value or parameter, the method proceeds through steps 1116 to 1122 where driveline torque is reduced to zero at step 1116, the second dog clutch is disengaged at step 1118, electric motor speed is increased to sync for the second gear ratio at step 1120, and the second dog clutch is engaged to the third layer of the driveline shaft at step 1122. After either step 1114 or 1122, the method proceeds to step 1124 where it is determined whether deceleration of the ISS is detected. If no deceleration is detected, the system stays in the current gear at step 1126 and the shift process 1100 is ended at step 1140. If deceleration is detected, the driveline torque is reduced to zero at step 1128, the second dog clutch is disengaged at step 1130, and the first dog clutch is disengaged at step 1132. Subsequently, the electric motor speed is increased to sync for the first gear ratio at step 1134, after which the second dog clutch is engaged to layer three of the driveline shaft at step 1136 while the first dog clutch is engaged to layer 1 of the driveline shaft at step 1138. The shifting process is then ended at step 1140.

With the above-described process, the transmission is controlled such that upshifts occur from second gear directly to fourth gear ratio and from first gear ratio directly to third gear ratio such that no shifting from second gear ratio to third gear ratio occurs during upshifting. Similarly, the transmission is controlled such that downshifts occur from fourth gear ratio directly to second gear ratio and from third gear ratio directly to first gear ratio such that no shifting from third gear ratio to second gear ratio occurs during downshifting. As shifts between second and third gear ratios require two synchronization steps, considerable time can be achieved with the above-outlined strategy. For example, calculated simulations show that the above-described upshifting strategies take only about 960 milliseconds (ms) while upshifting from second gear ratio to third gear ratio takes about 1850 ms. Similarly, calculated simulations show that the above-described downshifting strategies take only about 1030 ms while downshifting from third gear ratio to second gear ratio takes about 1780 ms. Accordingly, using the above-described upshifting and downshifting strategies in which shifting between second and third gear ratios is avoided can be advantageous in electric motor driven transmission applications.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some examples, some one or more of the most important method steps may be executed by such an apparatus.

Generally, examples of the present disclosure can be implemented through the use of computer program products with program codes, the program codes being operative for performing the operations described herein when the computer program product runs on a computer such as may be used to embody a controller operating the clutches 76, 86 and motor 10.

Although various examples and examples are described herein, those of ordinary skill in the art will understand that many modifications may be made thereto within the scope of the present disclosure. Accordingly, it is not intended that the scope of the disclosure in any way be limited by the examples provided.

1. A transmission comprising:
a) a shaft arrangement including an input shaft configured to couple to a prime mover and an output shaft coaxially aligned with the input shaft;
b) a plurality of drive gears supported by the shaft arrangement;
c) a countershaft arrangement including a first countershaft and a second countershaft supporting a plurality of pinion gears intermeshed with the plurality of drive gears;
d) an electromagnetic clutch arrangement to selectively lock the plurality of drive gears to the shaft arrangement to selectively provide at least two different gear ratios between the input and output shafts.

2. The transmission of claim 1, wherein the plurality of drive gears includes a first drive gear, a second drive gear, and a third drive gear.

3. The transmission of claim 1, wherein the electromagnetic clutch arrangement is operable to selectively lock the first drive gear to the input shaft, to selectively lock the second drive gear to the input shaft and to the output shaft, and to selectively lock the third drive gear to the output shaft, wherein the electromagnetic clutch arrangement includes a first electromagnetic clutch assembly and a second electromagnetic clutch assembly.

4. (canceled)

5. The transmission of claim 3, wherein the first electromagnetic clutch assembly is operable between:
a neutral position in which the first and second drive gears are rotatable with respect to the input shaft;
b) a first position in which the first drive gear is locked to the input shaft and the second drive gear is rotatable with respect to the input shaft; and
c) a second position in which the first drive gear is rotatable with respect to the input shaft and the second drive gear is locked to the input shaft.

6. The transmission of claim 5, wherein the second electromagnetic clutch assembly is operable between:
a) a neutral position in which the second and third drive gears are rotatable with respect to the output shaft;
b) a first position in which the second drive gear is locked to the output shaft and the third drive gear is rotatable with respect to the output shaft; and
c) a second position in which the second drive gear is rotatable with respect to the output shaft and the third drive gear is locked to the output shaft.

7. The transmission of claim 6, wherein the transmission is operable between:
a) a first gear ratio in which the first electromagnetic clutch assembly is in the first position and the second electromagnetic clutch assembly is in the second position;
b) a second gear ratio in which the first electromagnetic clutch assembly is in the second position and the second electromagnetic clutch assembly is in the second position;
c) a third gear ratio in which the first electromagnetic clutch assembly is in the first position and the second electromagnetic clutch assembly is in the first position; and
d) a fourth gear ratio in which the first electromagnetic clutch assembly is in the second position and the second electromagnetic clutch assembly is in the first position.

8. The transmission of claim 3, wherein the first and second electromagnetic clutch assemblies are supported by a pair of brackets supported by a housing assembly of the transmission.

9. (canceled)

10. The transmission of claim 1, wherein one of the plurality of drive gears includes a gear rim defining an internal space having an axial dimension, and wherein the electromagnetic clutch arrangement includes an electromagnetic clutch assembly located at least partially within the internal space such that a majority of an axial length of the electromagnetic clutch assembly is within the internal space.

11. The transmission of claim 1, further comprising a power take-off location driven by the countershaft arrangement, wherein the power take-off location has as least two possible gear speed ratios relative to the input shaft.

12. The transmission of claim 1, wherein the first and second countershafts are supported by cylindrical roller bearing assemblies at one end and by cylindrical roller bearing assemblies at an opposite end.

13. The transmission of claim 12, further comprising anti-rotation inserts located between a housing of the transmission and the roller bearing assemblies and between the housing and the cylindrical roller bearing assemblies.

14. The transmission of claim 1, wherein the input shaft is supported by an angular contact ball bearing assembly and by a roller bearing assembly.

15. The transmission of claim 14, wherein the roller bearing assembly is located at least partially within a cavity of the output shaft.

16. The transmission of claim 14, wherein the roller bearing assembly rotationally supports a thrust washer of an axial bearing assembly.

17. The transmission of claim 1, wherein the input shaft is axially supported by at least one bearing assembly.

18. (canceled)

19. (canceled)

20. (canceled)

21. The transmission of claim 1, further including a speed sensing rotor mounted to the output shaft, the speed sensing rotor including a plurality of spaced apart teeth extending at an oblique angle to a longitudinal axis of the transmission.

22. The transmission of claim 21, further including at least a first sensor having an axial length positioned orthogonally to the plurality of spaced apart teeth.

23. (canceled)

24. (canceled)

25. The transmission of claim 1, wherein the output shaft is supported by a bearing assembly that is press fit onto the output shaft, wherein a bearing sleeve is press fit onto the bearing assembly and is secured to the front housing by a plurality of fasteners, and
wherein the input shaft is supported by a bearing assembly that is press fit onto the input shaft, wherein a bearing sleeve is press fit onto the bearing assembly and is secured to the front housing by a plurality of fasteners.

26. (canceled)

27. (canceled)

28. (canceled)

29. A method of upshifting a transmission assembly driven by an electric motor, the method comprising:
a) providing a twin-countershaft transmission assembly including an input shaft, an output shaft, a first drive gear, a second drive gear, a third drive gear, a first dog clutch, and a second dog clutch, wherein the first and second dog clutches are positionable to selectively place the transmission assembly in one of a first, second, third, and fourth gear ratio;
b) positioning the first and second dog clutches such that the transmission is in the first gear ratio; and
c) upon receiving a first system upshift request, positioning the first and second dog clutches such that the transmission is shifted from the first gear ratio directly to the third gear ratio without shifting through the second gear ratio.

30. The method of claim 29, further comprising:
a) positioning the first and second dog clutches such that the transmission is in the second gear ratio; and
b) upon receiving a second system upshift request, positioning the first and second dog clutches such that the transmission is shifted from the second gear ratio directly to the fourth gear ratio without shifting through the third gear ratio.

31. (canceled)

32. (canceled)
